(19) United States
(12) Patent Application Publication
(10) Pub. No.: US 2010/0301718 A1
(43) Pub. Date: Dec. 2, 2010

(54) IMAGE FORMING APPARATUS AND MEMBER ALIGNING METHOD

(75) Inventor: Yoshihisa OTAKE, Shizouka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/791,673

(22) Filed: Jun. 1, 2010

Related U.S. Application Data
(60) Provisional application No. 61/183,398, filed on Jun. 2, 2009.

(51) Int. Cl. G03G 15/00; B23Q 3/00

(52) U.S. Cl. 312/223.1; 29/464

(57) ABSTRACT

An image forming apparatus includes: a first member configured to have a projecting section having a reference plane parallel to a projecting direction thereof; a second member configured to have a hole into which the projecting section is inserted, an aligning section that comes into contact with the reference plane of the projecting section inserted into the hole, and a deformation section that comes into contact with, in a state bent to the inserting direction side, a surface on an opposite side to the reference plane of the projecting section inserted into the hole.

### CROSS-REFERENCE TO RELATED APPLICATION(S)

This application is based upon and claims the benefit of priority from: U.S. provisional application 61/183,398, filed on Jun. 2, 2009, the entire contents of which are incorporated herein by reference.

### FIELD

This specification relates to a technique for alignment between members.

### BACKGROUND

In the past, as a method of aligning a main frame with a base frame included in a bottom frame of a main body of an image forming apparatus, methods (1) to (3) explained below are known.

(1) A method of fitting projections for alignment on the base frame in holes for alignment formed in the main frame to align the frames.
(2) A method of forming sections of a frame wall surface of the main frame in a projected shape and inserting the projected shape sections into holes for alignment provided in the base frame to align the frames.
(3) A method of aligning the base frame and the main frame using a jig for assembly for aligning the frames.

The methods in the past respectively have problems explained below.

(1) Since the projections provided on the main frame wall surface are fit in the holes for alignment on the base frame, bent sections are interposed between the frames and accuracy of alignment falls.
(2) When fluctuation in the material thickness of the main frame inserted into the holes for alignment of the base frame is taken into account, the holes for alignment of the base frame needs to be set rather large. Backlash occurs when the holes for alignment are large with respect to the material thickness.
(3) Since the jig for assembly is used, an increase in cost due to equipment investment and deterioration in assemblability occurs.

### BRIEF DESCRIPTION OF THE DRAWINGS

FIG. 1 is a schematic perspective view of an image forming apparatus;

FIG. 2 is a perspective view of a state in which a main frame is aligned with a base frame;

FIG. 3 is a diagram of an aligning mechanism on the main frame side;

FIG. 4 is a diagram of an aligning mechanism on the base frame side;

FIG. 5 is a perspective view of a state in which the main frame is aligned with the base frame;

FIG. 6 is a plan view of the state in which the main frame is aligned with the base frame;

FIG. 7 is a sectional view taken along A-A′ shown in FIG. 6 in a state before alignment;

FIG. 8 is a sectional view taken along A-A′ in FIG. 6 in a state after alignment;

FIG. 9 is a sectional view of the state before alignment; and

FIG. 10 is a sectional view of the state after alignment.

### DETAILED DESCRIPTION

In general, described herein relates to an image forming apparatus includes a first member and a second member. The first member has a projecting section having a reference plane parallel to a projecting direction thereof. The second member has a hole into which the projecting section is inserted, an aligning section that comes into contact with the reference plane of the projecting section inserted into the hole, and a deformation section that comes into contact with, in a state bent to an inserting direction side, a surface on the opposite side of the reference plane of the projecting section inserted into the hole.

### First Embodiment

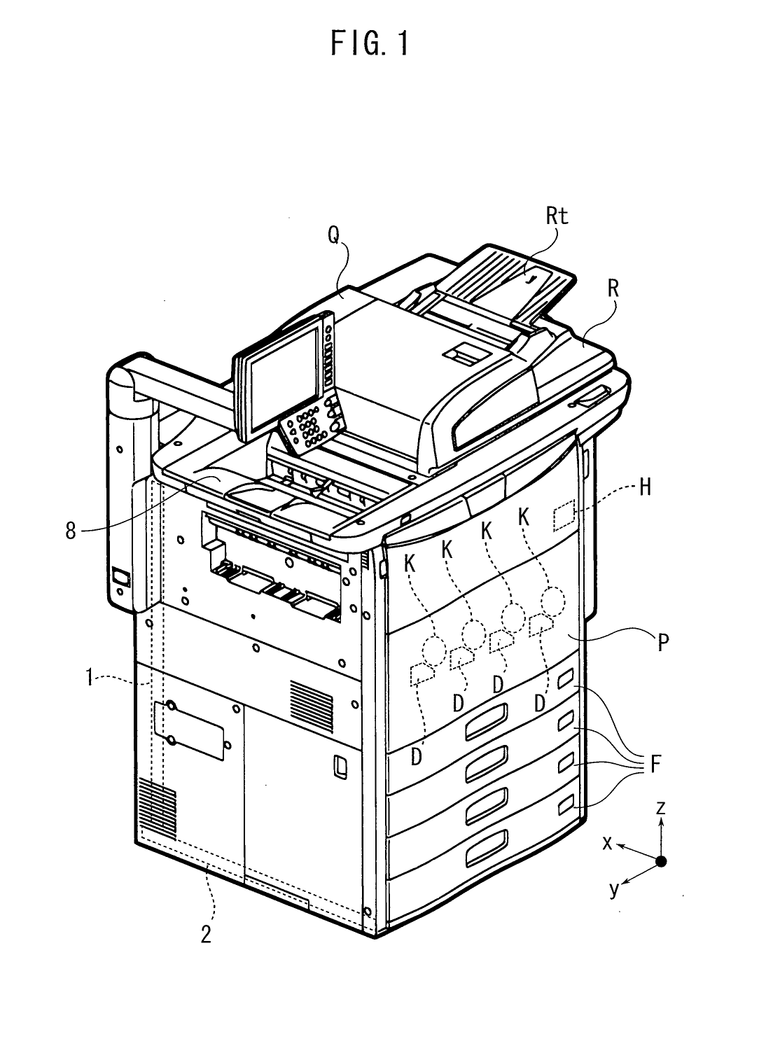

FIG. 1 is a schematic perspective view of an image forming apparatus.

The image forming apparatus includes an auto document feeder (ADF) V, an image reading unit R, an image forming unit P, and a discharge tray 8.

The auto document feeder V has a function of continuously automatically feeding plural original documents placed on a tray Rt to a position for document reading by the image reading unit R.

The image reading unit R is arranged above a main body of the image forming apparatus. The image reading unit R scans and reads images of a sheet document automatically fed by the auto document feeder V and a sheet document or a book document placed on a document placing table.

The image forming unit P includes conveying rollers, photoconductive drums K, developing devices D, and a fixing device H as a unit configured to execute at least a part of plural kinds of processing (sheet feeding processing, sheet conveyance processing, electrostatic latent image forming processing, development processing, fixing processing, sheet reversing processing, and sheet discharge processing) included in image forming processing. The image forming unit P forms, on the basis of, for example, an image read from an original document by the image reading unit R or image data received from an external apparatus by the image forming apparatus, developer images on a sheet fed from paper feeding cassettes.

The discharge tray 8 receives the sheet discharged to the outside of the apparatus after an image is formed thereon by the image forming unit P.

As indicated by a broken line in FIG. 1, the image forming apparatus includes a base frame 2 on the bottom. A main frame 1 is erected on the apparatus rear side on the upper surface of the base frame 2.

A mechanism for aligning the main frame 1 with the base frame 2 is explained below.

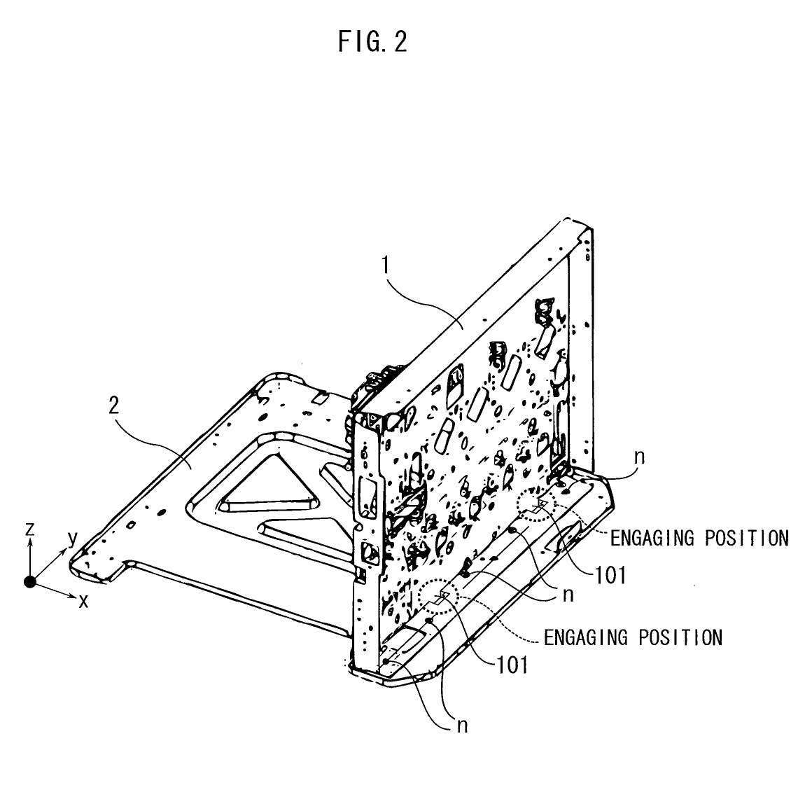

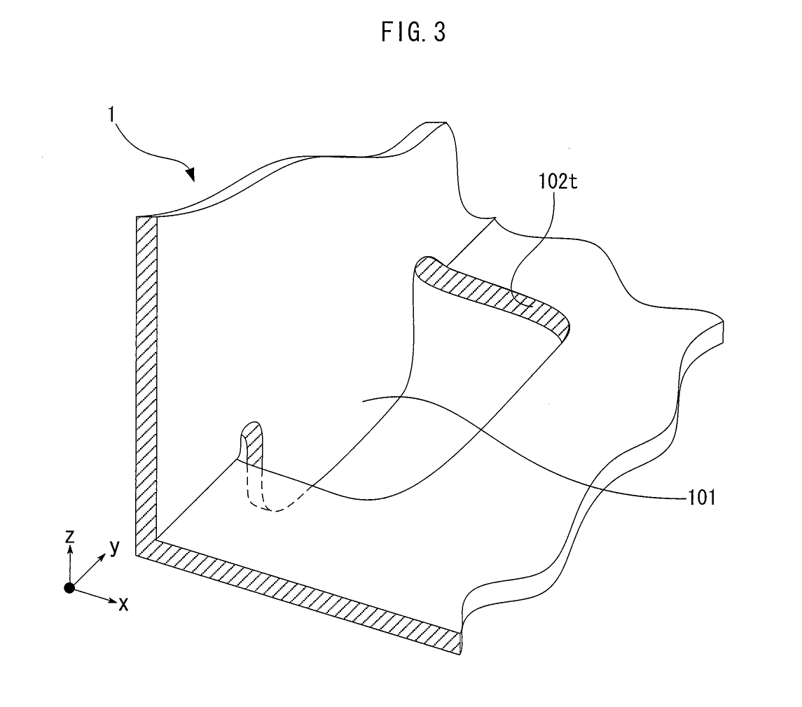

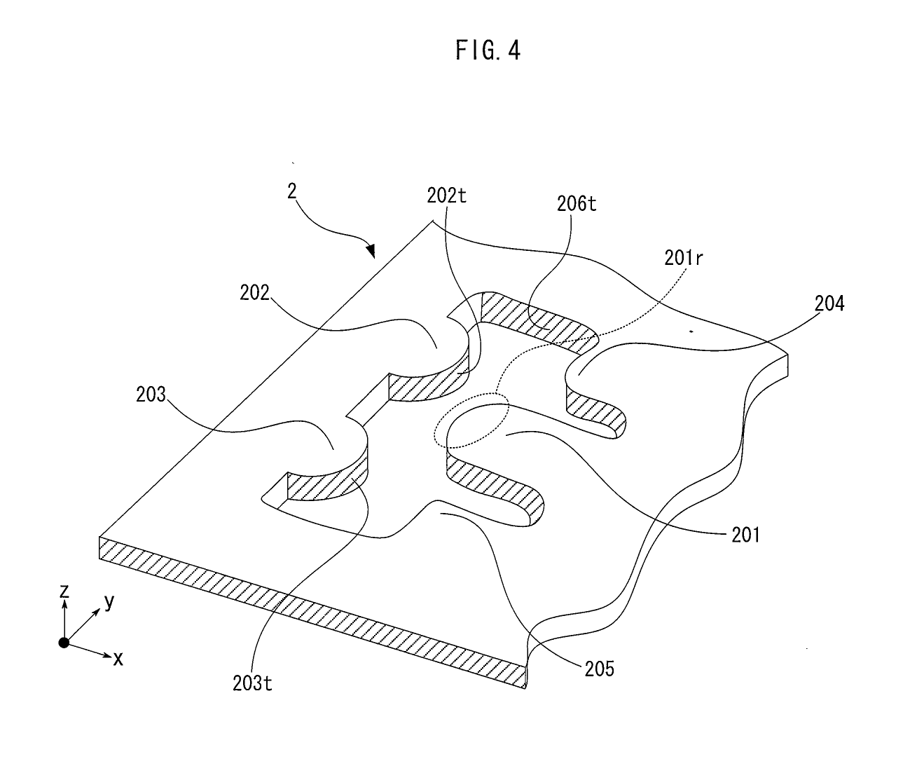

FIG. 2 is a perspective view of a state in which the main frame 1 is aligned with the base frame 2. FIG. 3 is a diagram of an aligning mechanism on the main frame 1 side. FIG. 4 is a diagram of an aligning mechanism on the base frame 2 side.

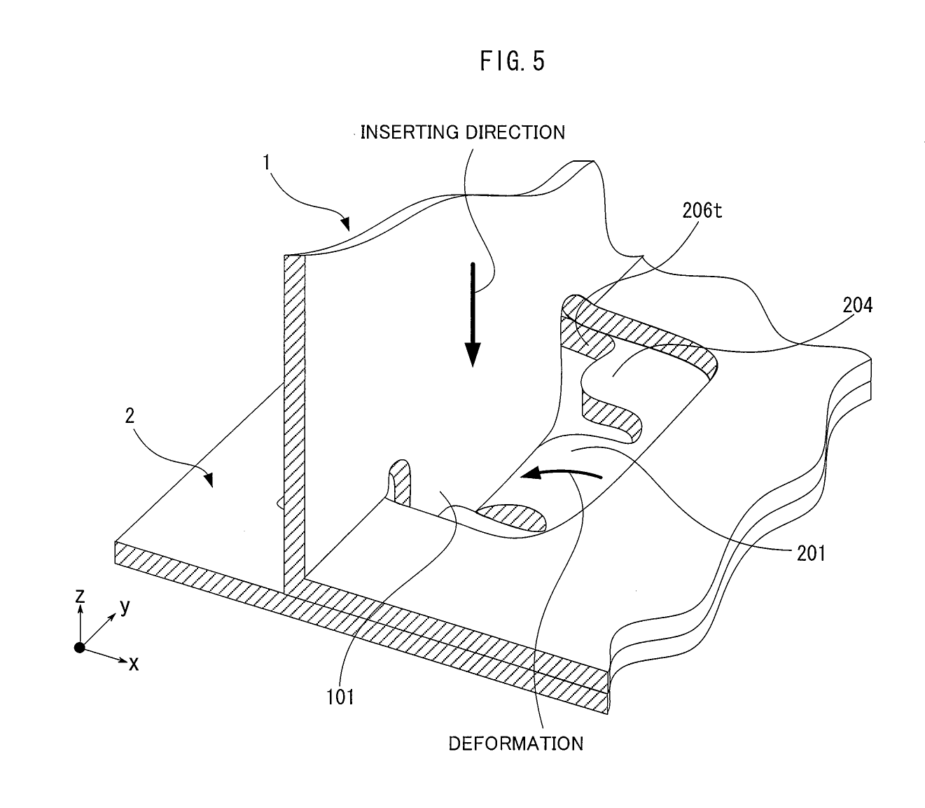

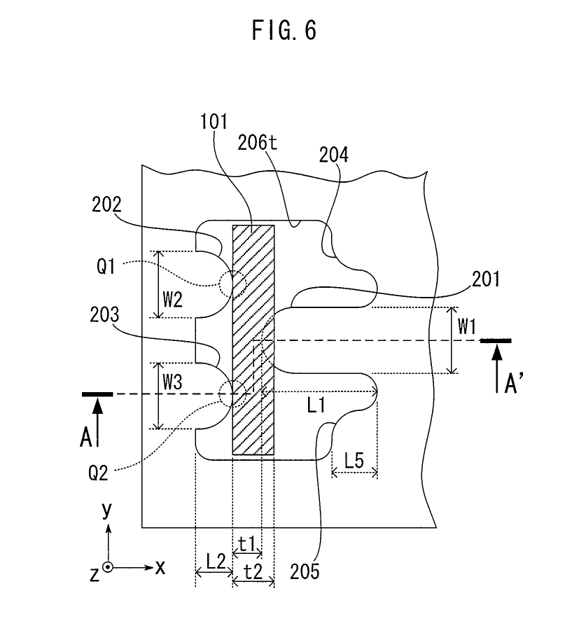

FIG. 5 is a perspective view of a state in which the main frame 1 is aligned with the base frame 2. FIG. 6 is a plan view of the state in which main frame 1 is aligned with the base frame 2.

The main frame 1 has projecting sections 101 projecting downward in a z axis direction (see FIG. 2) at the lower end of the main frame 1. Each of the projecting sections 101 has a reference plane 101s parallel to a projecting direction of the projecting section 101 from the main frame 1 (see, for example, FIG. 6).

The main frame 1 is formed by cutting, with press work or the like, a steel plate made of, for example, iron, stainless steel, or aluminum. In this case, the projecting sections 101 are formed in a tabular shape (see FIG. 3).

The main frame 1 supports at least one of the conveying rollers, the photoconductive drums K, the developing devices D, the fixing device H, and the like (see FIGS. 1 and 2).

As a method of projecting the projecting section 101 from the main frame 1, as shown in FIG. 3, the main frame 1 may be bent to project the projecting section 101 or the projecting section 101 may be bent to project from the main frame 1.

Like the main frame 1, the base frame 2 is formed by cutting, with press work or the like, a steel plate made of, for example, iron, stainless steel, or aluminum.

The base frame 2 is a base member of the image forming apparatus. The base frame 2 supports, for example, heavy load like a power source which supplies electrical power to the image forming apparatus and a sheet cassette (see, for example, FIGS. 1 and 2). Wheels are located on a bottom surface of the base frame 2 to move the image forming apparatus.

The base frame 2 has a hole 202h into which the projecting section 101 is inserted. Aligning sections 202 and 203 and a deformation section 201 are formed in the inner peripheral surface of the hole 202h.

The deformation section 201 extends from the inner peripheral surface of the hole 202h by length L1. The aligning sections 202 and 203 extend from the inner peripheral surface of the hole 202h by length L2. On both sides of the deformation section 201, corners 204 and 205 extend from the inner peripheral surface of the hole 202h by length L5.

The aligning sections 202 and 203 and the deformation section 201 are formed to have a curved surface shape at least at distal ends thereof (see, for example, FIG. 6).

As shown in FIG. 6, width W2 in a y axis direction of the aligning section 202 and width W3 in the y axis direction of the aligning section 203 are set to the same width. Width W1 of the deformation section 201 is also set to width substantially the same as the widths W2 and W3.

The deformation section 201 has an elongated shape compared with the aligning sections 202 and 203.

Therefore, a relation among an aspect ratio E1 (=L2/W2) of the aligning section 202, an aspect ratio E2 (=L2/W3) of the aligning section 203, and an aspect ratio E3 (=WW1) of the deformation section 201 is E1=E2<E3.

According to a difference among the aspect ratios, when the projecting section 101 is pressed against the aligning sections 202 and 203 and the deformation section 201, large stress is generated in the deformation section 201 and the deformation section 201 is easily deformed compared with the aligning sections 202 and 203.

The aligning section 202, the aligning section 203, and the deformation section 201 are arranged in positions different from one another in a direction (the y axis direction) orthogonal to an extending direction of the deformation section 201 (the z axis direction).

The aligning section 202, the aligning section 203, and the deformation section 201 are alternately arranged. Therefore, it is unnecessary to make a press blade, which is used in cutting the base frame 2 with press work, excessively thin. The distal ends of the aligning section 202, the aligning section 203, and the deformation section 201 are formed in a curved surface shape. This makes it easy to form the base frame 2 with press work.

The projecting section 101 is formed in a tabular shape. As shown in FIG. 6, when the projecting section 101 is inserted into the hole 202h, an interval t1 between the distal end of the deformation section 201 and the distal end of the projecting section 101 in the extending direction of the deformation section 201 (the x axis direction) is smaller than thickness t2 of the projecting section 101 in a direction orthogonal to the reference plane 101s.

An end 202t of the aligning section 202 and an end 203t of the aligning section 203 come into contact with the reference plane 101s of the projecting section 101 (see positions Q1 and Q2 in FIG. 6) in a state in which the projecting section 101 is inserted into the hole 202h.

The deformation section 201 comes into contact with, in a state bent to an inserting direction side (see, for example, FIG. 5), a surface 101u on the opposite side to the reference plane 101s of the projecting section 101 inserted into the hole 202h.

A sidewall 102t of a hole formed by punching through the projecting section 101 in the main frame 1 has width substantially the same as the width of a sidewall 206t of the hole. Therefore, a side end surface of the projecting section 101 can be aligned by the sidewall 206t of the hole.

A method of aligning the main frame 1 (a first member) with the base frame 2 (a second member) is explained.

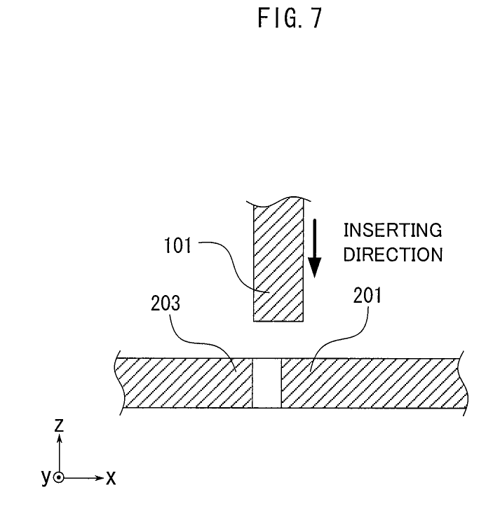

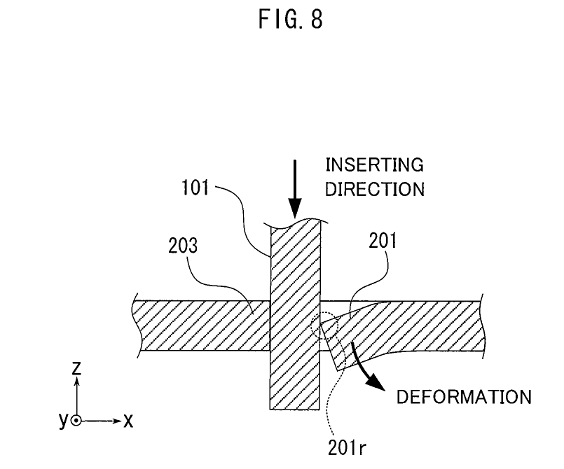

FIG. 7 is a sectional view taken along A-A′ in FIG. 6 in a state before alignment. FIG. 8 is a sectional view taken along A-A′ in FIG. 6 in a state after alignment.

First, the reference plane 101s of the projecting section 101 of the main frame 1 is brought into contact with the end 202t of the aligning section 202 and the end 203t of the aligning section 203 of the base frame 2 to generally align the projecting section 101 with the hole 202h.

Subsequently, while keeping the reference plane 101s in contact with the end 202t of the aligning section 202 and the end 203t of the aligning section 203, the distal end in the inserting direction of the projecting section 101 is pressed against a distal end 201r of the deformation section 201 to insert the deformation section 201 into the hole 202h while bending the deformation section 201 to the inserting direction side (see FIG. 8).

The projecting section 101 is inserted into the depth of the hole 202h, whereby alignment of the main frame 1 with the base frame 2 is completed.

When the alignment of the main frame 1 with the base frame 2 is completed, the main frame 1 is screwed to the base frame 2 in the positions of plural screw holes n formed in the main frame 1.

When the projecting section 101 of the main frame 1 is inserted into the hole 202h of the base frame 2, the deformation section 201 presses, while bending downward, the projecting section 101 of the main frame 1 against the aligning sections 202 and 203. Pressing force by the deformation section 201 and alignment by the aligning sections 202 and 203 cooperate with each other. This makes it possible to realize highly accurate alignment of the main frame 1 with the base frame 2 without backlash.

The projecting section 101 only has to be able to be inserted into the hole 202h. The reference plane 101s of the projecting section 101 only has to come into contact with the ends of the aligning sections 202 and 203 with the pressing force by the deformation section 201. Therefore, fluctuation in material thickness of the projecting section 101 of the main frame 1 can be absorbed by the deformation of the deformation section 201. It is possible to perform flexible alignment less easily affected by the influence of material thickness of a frame.

Further, a special jig for assembly or the like is unnecessary to perform alignment of the main frame 1 with the base frame 2. Therefore, there is an effect that work efficiency is high and equipment investment is unnecessary.

### Second Embodiment

A second embodiment is a modification of the first embodiment. Components same as those explained in the first embodiment are denoted by the same reference numerals and signs and explanation of the components is omitted.

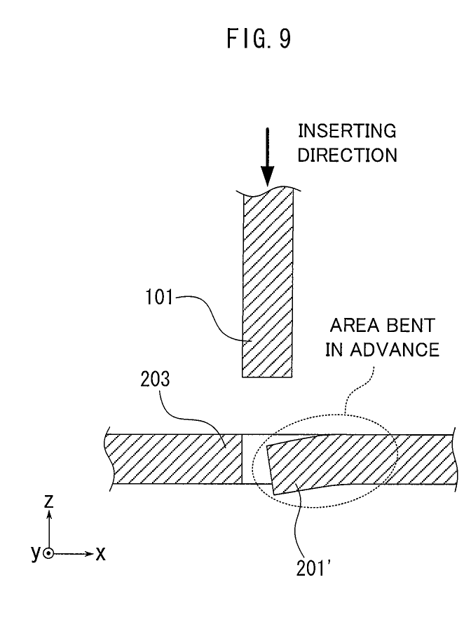

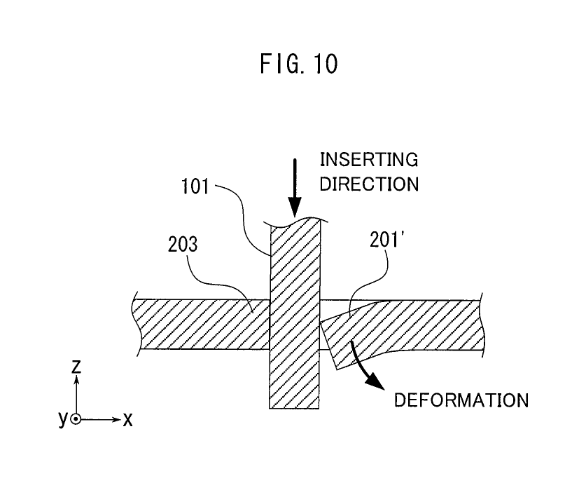

FIG. 9 is a sectional view of a state before alignment. FIG. 10 is a sectional view of a state after alignment. A direction of a section shown in FIGS. 9 and 10 is the same as the direction of the section A-A′ shown in FIG. 6.

A deformation section 201′ of the base frame 2 in the second embodiment is bent to the inserting direction side in advance (see FIG. 9).

The deformation section 201' is deformed to the inserting direction side in advance. This makes it possible to set a distal end position of the deformation section 201' in a position lower than the surface of the base frame 2.

The projecting section 101 of the main frame 1 is aligned with a recess formed on the base frame 2 by deforming the deformation section 201′ in advance. This makes it possible to easily align the projecting section 101 with the hole 202h of the base frame 2.

The configuration for aligning the main frame with the base frame is explained above. However, the configuration can be flexibly applied between members for which relative alignment is necessary.

In the above explanation, the projecting sections are provided only in one member and the holes are provided in the other member. However, it is also possible to provide the projecting sections and the holes in one member and also provide the projecting sections and the holes in the other member.

The present invention can be carried out in other various forms without departing from the spirit and the main characteristics of the present invention. Therefore, the embodiments are merely exemplars in every aspect and should not be limitedly interpreted. The scope of the present invention is indicated by the scope of claims and is by no means restricted by the text of the specification. Further, all modifications and various improvements, substitutions, and alterations belonging to the scope of equivalents of the scope of claims are within the scope of the present invention.

As explained in detail above, according to the techniques described in this specification, it is possible to perform highly accurate alignment between two members without using a special tool.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image forming apparatus comprising:
a unit configured to execute at least a part of image forming process;
a first member comprising a projecting section including a reference plane parallel to a projecting direction thereof, configured to support the unit;
a second member comprising a hole into which the projecting section is inserted, an aligning section to contact with the reference plane of the projecting section inserted into the hole, and a deformation section to contact with a surface on an opposite side to the reference plane of the projecting section inserted into the hole in a state bent to the inserting direction side.

2. The apparatus according to claim 1, wherein the aligning section and the deformation section form an inner peripheral surface of the hole.

3. The apparatus according to claim 1, wherein
the deformation section and the aligning section extend from the inner peripheral surface of the hole, and
the aligning section and the deformation section are arranged in positions different from each other in a direction orthogonal to an extending direction of the deformation section.

4. The apparatus according to claim 3, wherein
the projecting section is formed in a tabular shape, and
when the projecting section is inserted into the hole, an interval between a distal end of the deformation section and a distal end of the projecting section in the extending direction of the deformation section is smaller than thickness of the projecting section in a direction orthogonal to the reference plane.

5. The apparatus according to claim 1, wherein the aligning section is formed as a curved surface at a distal end thereof.

6. The apparatus according to claim 1, wherein the deformation section is formed as a curved surface at a distal end thereof.

7. The apparatus according to claim 1, wherein
the first member is a frame configured to support a photoconductive member, and
the second member is a base frame configured to support at least one of a power source and a sheet cassette.

8. The apparatus according to claim 1, wherein
the first member is a frame configured to support a conveying roller, and
the second member is a base frame configured to support at least one of a power source and a sheet cassette.

9. The apparatus according to claim 1, wherein
the first member is a frame configured to support a fixing device, and
the second member is a base frame configured to support at least one of a power source and a sheet cassette.

10. The apparatus according to claim 1, wherein the deformation section is formed in a shape having an aspect ratio higher than that of the aligning section.

11. A member aligning method comprising:
aligning a projecting section of a first member comprising a reference plane parallel to a projecting direction thereof with a hole formed in the second member by bringing the reference plane of the projecting section into contact with an aligning section of a second member; and
inserting the projecting section into the hole of the second member while pressing a distal end in an inserting direction of the projecting section against a deformation section of the second member to bend the deformation section to the inserting direction side.

12. The method according to claim 11, wherein the aligning section and the deformation section form an inner peripheral surface of the hole.

13. The method according to claim 11, wherein
the deformation section and the aligning section extend from the inner peripheral surface of the hole, and
the aligning section and the deformation section are arranged in positions different from each other in a direction orthogonal to an extending direction of the deformation section.

14. The method according to claim 13, wherein
the projecting section is formed in a tabular shape, and
when the projecting section is inserted into the hole, an interval between a distal end of the deformation section and a distal end of the projecting section in the extending direction of the deformation section is smaller than thickness of the projecting section in a direction orthogonal to the reference plane.

15. The method according to claim 11, wherein the aligning section is formed as a curved surface at a distal end thereof.

16. The method according to claim 11, wherein the deformation section is formed as a curved surface at a distal end thereof.

17. The method according to claim 11, wherein
the first member is a frame configured to support a photoconductive member, and
the second member is a base frame configured to support at least one of a power source and a sheet cassette.

18. The method according to claim 11, wherein
the first member is a frame configured to support at least one of a conveying roller and a fixing device, and
the second member is a base frame configured to support at least one of a power source and a sheet cassette.

19. The method according to claim 11, wherein the deformation section is formed in a shape that is more easily deformed than the aligning section when the projecting section is inserted into the hole.

20. The method according to claim 11, wherein the deformation section of the second member is bent to the inserting direction side in advance.
